(19) United States
(12) Patent Application Publication
(10) Pub. No.: US 2018/0287881 A1
(43) Pub. Date: Oct. 4, 2018

(54) CONTAINER REGISTRATION DEVICE AND CONTAINER REGISTRATION METHOD THEREFOR

(71) Applicant: FUJITSU LIMITED, Kawasaki-shi (JP)

(72) Inventors: Nobuyuki KUROMATSU, Kawasaki (JP); Haruyasu Ueda, Ichikawa (JP)

(73) Assignee: FUJITSU LIMITED, Kawasaki-shi (JP)

(21) Appl. No.: 15/928,169

(22) Filed: Mar. 22, 2018

(30) Foreign Application Priority Data
Mar. 31, 2017 (JP) 2017-070491

(51) Int. Cl. H04L 12/24

(52) U.S. Cl. CPC H04L 41/12

(57) ABSTRACT

When a container generated on a server is started up, an apparatus generates related information indicating that the container has been generated on the server while referring to environmental information of the server that is stored on the server. When causing a file system that retains topology information indicating connection relationship among a plurality of servers and network devices to perform registration processing of the container, the apparatus causes the topology information to be updated to include connection relationship between the container that has been generated based on the related information and the server.

### CROSS-REFERENCE TO RELATED APPLICATION

This application is based upon and claims the benefit of priority of the prior Japanese Patent Application No. 2017-70491, filed on Mar. 31, 2017, the entire contents of which are incorporated herein by reference.

### FIELD

The embodiment discussed herein is related to a container registration device and a container registration method therefor.

### BACKGROUND

For example, a business operator providing a service to a user (hereinafter, also referred to as a business operator, simply) establishes a business system for performing provision of a service (hereinafter, also referred to as an information processing system) and operates the business system. Specifically, when establishing the business system, the business operator uses a container-based virtualization technique being a technique for effectively performing provision of a service, for example.

A container-based virtualization technique is a technique with which a container which is an environment isolated from a server (hereinafter, also referred to as a host) is generated on the server. Specifically, with a container-based virtualization technique, when generation of a container is performed, unlike with a hypervisor-based virtualization technique, generation of a guest operating system (OS) does not have to be performed. For this reason, a business system using a container-based virtualization technique has an advantage that, compared with a business system using a hypervisor-based virtualization technique, an overhead for generation of a container is smaller (see Japanese National Publication of International Patent Application No. 2015-524596, for example).

### SUMMARY

According to an aspect of the invention, when a container generated on a server is started up, an apparatus generates related information indicating that the container has been generated on the server while referring to environmental information of the server that is stored on the server. When causing a file system that retains topology information indicating connection relationship among a plurality of servers and network devices to perform registration processing of the container, the apparatus causes the topology information to be updated to include connection relationship between the container that has been generated based on the related information and the server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a diagram explaining a hardware configuration of a server;

FIG. 3 is a diagram explaining a hardware configuration of a management device;

FIG. 4 is a functional block diagram of the server;

FIG. 5 is a functional block diagram of a container generated on the server;

FIG. 6 is a functional block diagram of the management device;

FIG. 7 is a flowchart explaining an outline of registration processing in a first embodiment;

FIG. 8 is a diagram explaining the outline of the registration processing in the first embodiment;

FIG. 9 is a diagram explaining the outline of the registration processing in the first embodiment;

FIG. 10 is a diagram explaining the outline of the registration processing in the first embodiment;

FIG. 11 is a diagram explaining the outline of the registration processing in the first embodiment;

FIG. 12 is a flowchart explaining details of the registration processing in the first embodiment;

FIG. 13 is a flowchart explaining the details of the registration processing in the first embodiment;

FIG. 14 is a flowchart explaining the details of the registration processing in the first embodiment;

FIG. 15 is a flowchart explaining the details of the registration processing in the first embodiment;

FIG. 16 is a flowchart explaining the details of the registration processing in the first embodiment;

FIG. 17 is a flowchart explaining the details of the registration processing in the first embodiment;

FIGS. 18A and 18B are diagrams explaining specific examples of environmental information and related information;

FIG. 19 is a diagram explaining a specific example of topology information;

FIG. 20 is a diagram explaining the details of the registration processing in the first embodiment;

FIG. 21 is a diagram explaining a specific example of the topology information; and

FIG. 22 is a diagram explaining the details of the registration processing in the first embodiment.

### DESCRIPTION OF EMBODIMENT

In a file system that transversely manages pieces of data in containers, for example, when a copy of data in one container (hereinafter, also referred to as copied data) is generated, the copied data is preferably stored in a container generated in a different server from the server on which the container is generated. With this, even when a failure of a device or the like disables access to a server, the file system is able to access targeted data.

However, a container generated by a container-based virtualization technique is similar to a virtual machine by a hypervisor-based virtualization technique in that the container functions as a different environment from a server. For this reason, various functions of the file system operated in each container are not able to acquire information on the server on which the container is generated, in some cases. With this, in the file system, copied data for data in one container may be generated in the same server, whereby data copy with the redundancy secured is disabled in some cases.

It is preferable to enable data copy with the redundancy secured.

[Configuration of Information Processing System]

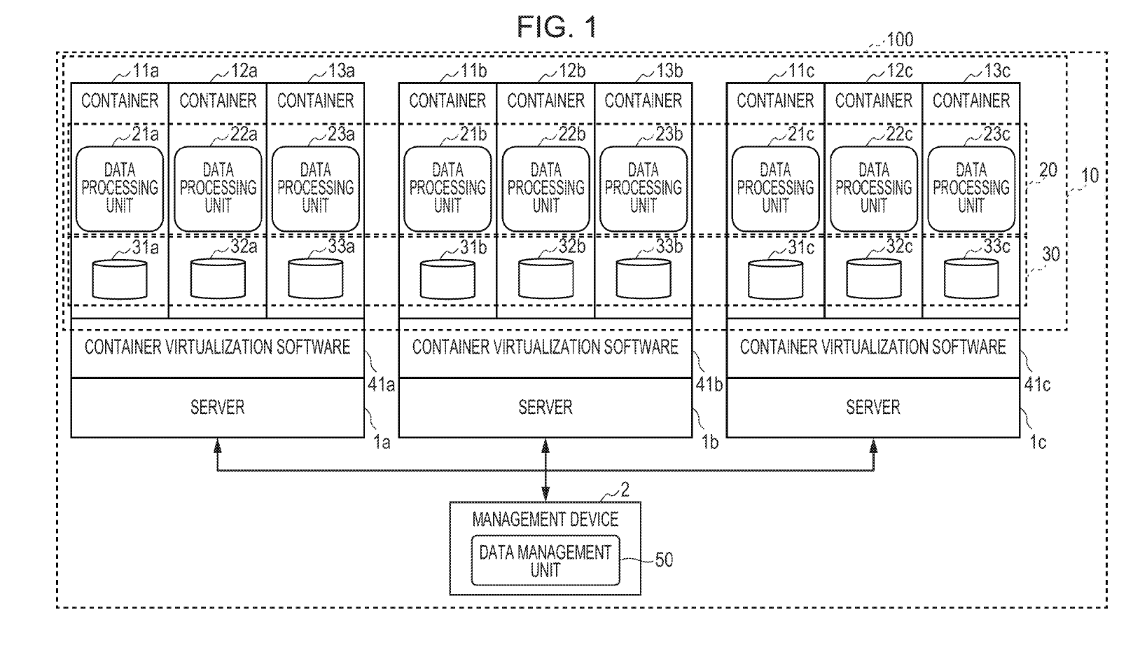

Firstly, a configuration of an information processing system 100 will be explained. FIG. 1 is a diagram illustrating the configuration of the information processing system 100. The information processing system 100 illustrated in FIG. 1 includes the servers 1a, 1b, and 1c (hereinafter, also referred to as a server 1, collectively) and a management device 2. It is to be noted that the servers 1b and 1c have the same configuration as that of the server 1a. Explanation of the servers 1b and 1c thus will be omitted below as appropriate.

The server 1a is a physical machine in which a container (hereinafter, also referred to as a registration device) being an environment isolated from the server 1a is generated. Specifically, the server 1a illustrated in FIG. 1 operates container virtualization software 41a performing startup (generation) and stop of a container, thereby starting up containers (hereinafter, also referred to as container registration devices) 11a, 12a, and 13a on the server 1a. Each of the containers 11a, 12a, and 13a in this case mounts the corresponding one of information storage regions 31a, 32a, and 33a, which is an information storage region (disk) of the server thereof, and uses the corresponding one as an information storage region of a subject container. As the container virtualization software, Docker® provided by Docker Inc. is known, for example.

Furthermore, in the containers 11a, 12a, and 13a illustrated in FIG. 1, data processing units 21a, 22a, and 23a composing a file system are operated, respectively. In the containers 11b, 12b, and 13b illustrated in FIG. 1, data processing units 21b, 22b, and 23b composing a file system are operated, respectively. In the containers 11c, 12c, and 13c illustrated in FIG. 1, data processing units 21c, 22c, and 23c composing a file system are operated, respectively. For example, when there is a request for processing with respect to data stored in any of the information storage regions 31a, 32a, and 33a (for example, a request for writing or reading), the corresponding one of the data processing units 21a, 22a, and 23a performs processing for the request for processing. In a manner similar

It is to be noted that hereinafter, each container generated on the servers 1a, 1b, and 1c (container 11a, for example) is also referred to as a container 10, collectively. Furthermore, each data processing unit operated on the servers 1a, 1b, and 1c (the data processing unit 21a, for example) is also referred to as a data processing unit 20, collectively. Furthermore, each information storage region mounted by each container 10 (information storage region 31a, for example) is also referred to as an information storage region 30, collectively. Further, “units” referred to in the specification may be implemented using a processor.

The management device 2 is operated by a data management unit 50 composing the file system. That is to say, the file system operated in the information processing system 100 illustrated in FIG. 1 is composed of the data processing unit 20 and the data management unit 50.

The data management unit 50 performs central management of the information storage region 30 storing data processed by the data processing unit 20 operated on the servers 1a, 1b, and 1c, for example. Specifically, the data management unit 50, in the example illustrated in FIG. 1, determines the information storage region 33c as the information storage region for storing copied data of data (or a block being a part of the data) stored in the information storage region 31a, for example. The data management unit 50 in this case instructs the data processing unit 23c, which manages data stored in the information storage region 33c, to store the copied data of the data stored in the information storage region 31a in the information storage region 33c.

It is to be noted that the file system composed by the data processing unit 20 and the data management unit 50 may be, for example a Hadoop Distributed File System (HDFS) by Hadoop® being a middleware that performs parallel distributed processing with a large amount of data arranged to be distributed into a plurality of machines, for example. In this case, the data processing unit 20 corresponds to a slave node in the HDFS and the data management unit 50 corresponds to a master node in the HDFS.

In the file system explained with reference to FIG. 1, for example, when copied data of data stored in the information storage region 31a is generated, the copied data is preferably stored in a different server from the server 1a that has the information storage region 31a (server 1b or 1c). This enables continuous access to the data in the file system even when a failure of a device or the like disables access to some of the server 1.

However, the container 10 generated by a container-based virtualization technique is similar to a virtual machine by a hypervisor-based virtualization technique in that the container 10 functions as a different environment from the server 1. For this reason, various functions of the file system operated in each container 10 are not able to acquire information on the server 1 on which that container 10 is generated, in some cases. With this, in the file system, copied data of data in one of the container 10 may be generated in a container 10 on the same server 1, whereby data copy with the redundancy secured is disabled in some cases.

In view of this, each container 10 according to the present embodiment refers to environmental information stored on the server 1 to generate information indicating that the container 10 has been generated on the server 1 (hereinafter, also referred to as related information) when the container 10 performs startup of the subject container 10. Thereafter, when causing the file system that retains information indicating connection relationship among a plurality of servers and network devices (hereinafter, also referred to as topology information) to perform registration processing of the subject container 10, the container 10 updates (generates) topology information to include connection relationship between the container 10 that has been generated based on the related information and the server 1 and causes the file system to retain the topology information.

That is to say, each server 1 enables the environmental information that identifies the subject server 1 to be referred by the container 10 generated on the subject server 1 in advance. Thereafter, when the container 10 performs startup of the subject container 10, each container 10 registers to the file system information including the information that identifies the subject container 10 and the information that identifies the server 1 on which the subject container 10 has been generated.

With this configuration, even when not having information of the server 1 on which the container 10 has been generated, the file system (data management unit 50) is able to register the information of the server 1 and the information of the container 10 generated on that server 1 in a manner associated with each other. This enables the file system to inhibit copied data of data in each container 10 from being generated in any container 10 on the same server 1.

Although a case where the data management unit 50 performs an operation in the management device 2 will be explained below, the data management unit 50 may perform an operation in any of the container 10 generated on the server 1.

[Hardware Configuration of Information Processing System]

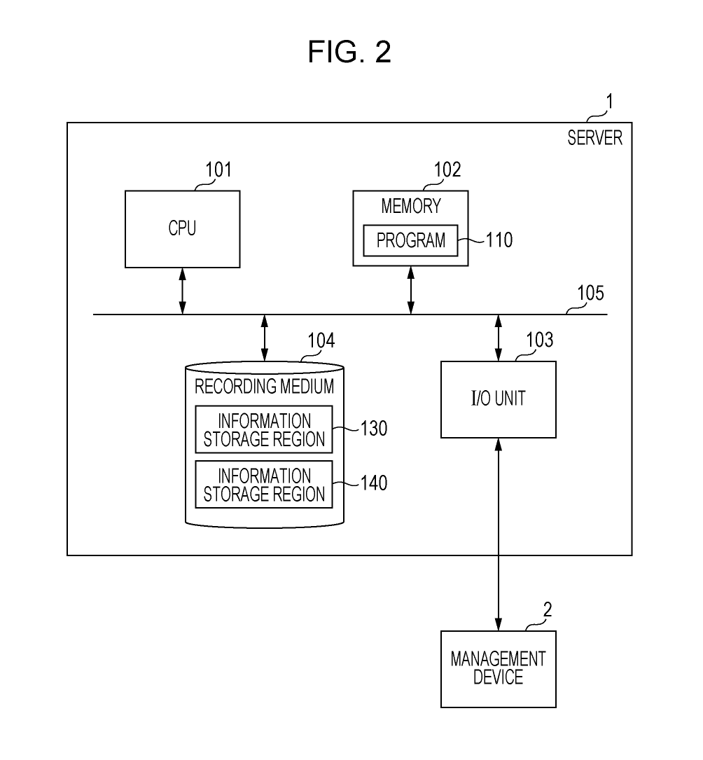

Next, a hardware configuration of the server 1 will be explained. FIG. 2 is a diagram explaining a hardware configuration of a server 1.

The server 1 includes a CPU 101 being a processor, a memory 102, an external interface (I/O unit) 103, and a recording medium 104. The above-described units are connected among each other via a bus 105.

The recording medium 104 records a program 110 for performing processing of registering information of the container 10 that has been started up (hereinafter, also referred to as registration processing) in a program storage region (not illustrated) within the recording medium 104, for example. Furthermore, the recording medium 104 includes an information storage region 130 (hereinafter, also referred to as a storage unit 130) and an information storage region 140 (hereinafter, also referred to as a storage unit 140) that store information used when the registration processing is performed, for example.

The CPU 101 loads the program 110 into the memory 102 from the recording medium 104 when the program 110 is executed and performs the registration processing in cooperation with the program 110. Furthermore, the external interface 103 performs communication with the management device 2, for example.

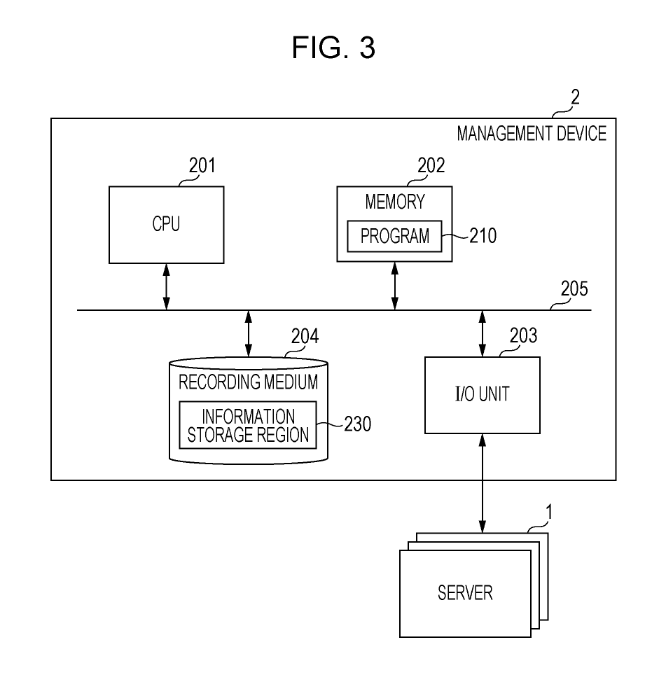

Next, a hardware configuration of the management device 2 will be explained. FIG. 3 is a diagram explaining the hardware configuration of the management device 2.

The management device 2 includes a CPU 201 being a processor, a memory 202, an external interface (I/O unit) 203, and a recording medium 204. The above-described units are connected among each other via a bus 205.

The recording medium 204 records a program 210 for performing the registration processing in a program storage region (not illustrated) within the recording medium 204, for example. Furthermore, the recording medium 204 includes an information storage region 230 (hereinafter, also referred to as a storage unit 230) that stores information used when the registration processing is performed, for example.

The CPU 201 loads the program 210 into the memory 202 from the recording medium 204 when the program 210 is executed and performs the registration processing in cooperation with the program 210. Furthermore, the external interface 203 performs communication with the server 1, for example.

[Function of Information Processing System]

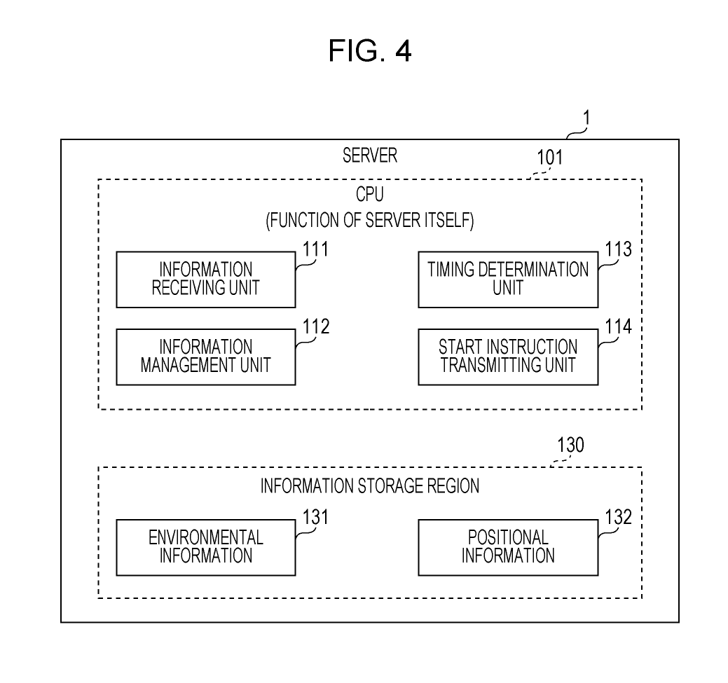

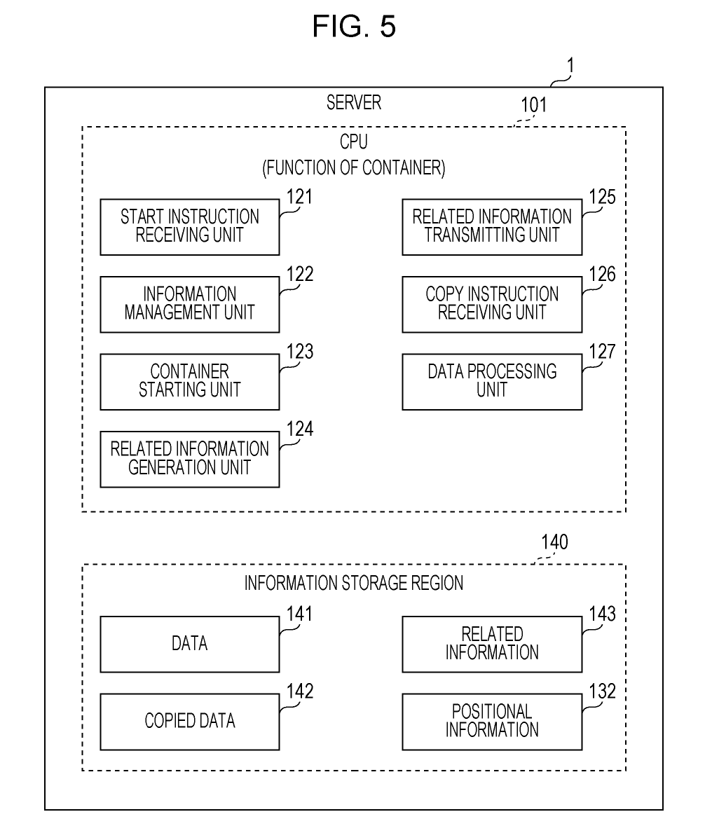

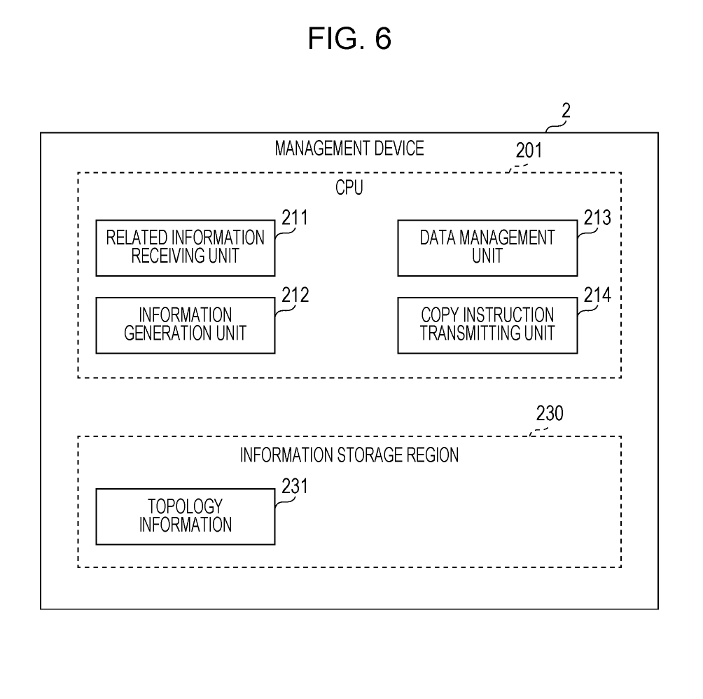

Next, a function of the information processing system 100 will be explained. FIG. 4 is a functional block diagram of the server 1. FIG. 5 is a functional block diagram of the container 10 generated on the server 1. FIG. 6 is a functional block diagram of the management device 2.

Firstly, the functional block diagram of the server 1 will be explained. The CPU 101 of the server 1 cooperates with the program 110 and thereby operates as a function of the server 1 itself, for example, as an information receiving unit 111, an information management unit 112, a timing determination unit 113, and a start instruction transmitting unit 114. Furthermore, in the information storage region 130, environmental information 131 and positional information 132 are stored, for example.

The information receiving unit 111 receives the environmental information 131 transmitted by a business operator via an operation terminal (not illustrated), for example. The environmental information 131 is information including identification information that identifies the subject server 1, for example. Furthermore, the information receiving unit 111 receives the positional information 132 transmitted by the business operator via the operation terminal, for example. The positional information 132 is information indicating a storage position of the environmental information 131 (storage position in the information storage region 130). It is to be noted that when the business operator has input the environmental information 131 or the positional information 132 directly on the server 1, the information receiving unit 111 may receive the input information.

When the information receiving unit 111 has received the environmental information 131, the information management unit 112 stores the received environmental information 131 in the information storage region 130. Furthermore, when the information receiving unit 111 has received the positional information 132, the information management unit 112 stores the received positional information 132 in the information storage region 130.

The timing determination unit 113 determines whether the timing to start up the container 10 has come. Specifically, when the information receiving unit 111 has received from the operation terminal (business operator) information that the container 10 is started up, the timing determination unit 113 determines that the timing to start up the container 10 has come, for example. Furthermore, when the current time reaches a time indicated by container start information (not illustrated) stored in advance in the information storage region 130, the timing determination unit 113 determines that the timing to start up the container 10 has come, for example.

When the timing determination unit 113 has determined that the timing to start up the container 10 has come, the start instruction transmitting unit 114 transmits a start instruction to the container 10. Furthermore, in this case, the start instruction transmitting unit 114 performs transmission of the positional information 132 stored in the information storage region 130 together with the start instruction. It is to be noted that when the business operator has performed an input for starting up the container 10 via the operation terminal, the start instruction transmitting unit 114 may perform transmission of the start instruction to the container 10.

Next, the functional block diagram of the container 10 generated on the server 1 will be explained. The CPU 101 of the server 1 cooperates with the program 110 and thereby operates as a function of the container 10, for example, as a start instruction receiving unit 121, an information management unit 122, a container starting unit 123, a related information generation unit 124 (hereinafter, also referred to as an information generation unit 124), a related information transmitting unit 125 (hereinafter, also referred to as a registration instruction unit 125), a copy instruction receiving unit 126, and a data processing unit 127. Furthermore, in the information storage region 140, data 141, copied data 142, related information 143, and the positional information 132 are stored, for example.

The start instruction receiving unit 121 receives the start instruction and the positional information 132 transmitted by the start instruction transmitting unit 114. When the start instruction receiving unit 121 has received the positional information 132, the information management unit 122 stores the received positional information 132 in the information storage region 140. Furthermore, the container starting unit 123 starts up the container 10 whose information is included in the start instruction in response to the start instruction receiving unit 121 having received the start instruction.

The related information generation unit 124 refers to the positional information 132 stored in the information storage region 140 and identifies the storage position of the environmental information 131 in the information storage region 130 on the server 1. The related information generation unit 124 then accesses the identified storage position to acquire the environmental information 131. Furthermore, the related information generation unit 124 refers to the acquired environmental information 131 and generates the related information 143 indicating that the container 10 has been generated on the server 1. Specifically, the related information generation unit 124 generates the related information 143 to include the identification information of the server 1 that is included in the acquired environmental information 131 and the identification information of the container 10 that has been started up by the container starting unit 123. Thereafter, the information management unit 122 stores the related information 143 generated by the related information generation unit 124 in the information storage region 140.

The related information transmitting unit 125 transmits the related information 143 stored in the information storage region 140 to the management device 2.

The copy instruction receiving unit 126 receives an instruction to generate the copied data 142 of the data 141 stored in other container 10 from the management device 2 (hereinafter, also referred to as a copy instruction).

When there is a request for processing with respect to the data 141 stored in the information storage region 140 (for example, a request for writing or reading), the data processing unit 127 performs processing for the request for processing. The data 141 is data to be referred to when the business system established in the container 10 is operated, for example.

Furthermore, when the copy instruction receiving unit 126 has received the copy instruction of the data 141, the data processing unit 127 generates the copied data 142 of the data 141 stored in other container 10 and stores the generated copied data 142 in the information storage region 140 of the subject container 10.

Next, the functional block diagram of the management device 2 will be explained. The CPU 201 of the management device 2 cooperates with the program 210 and thereby operates, for example, as a related information receiving unit 211, an information generation unit 212, a data management unit 213, and a copy instruction transmitting unit 214. Furthermore, in the information storage region 230, topology information 231 is stored, for example.

The related information receiving unit 211 receives the related information 143 transmitted by the related information transmitting unit 125. When the related information receiving unit 211 has received the related information 143, the information generation unit 212 generates (updates) the topology information 231 based on the contents of the received related information 143. The topology information 231 is information associating the identification information of each server and the identification information of each container generated on the server. That is to say, the information generation unit 212 in this case generates (updates) the topology information 231 to include information associating the identification information of the server 1 and the identification information of the container 10 generated on the server 1.

The data management unit 213 determines whether the data 141 stored in the information storage region 140 in the container 10 is to be copied. Specifically, in the data 141 stored in the information storage region 140 of the container 10, when the data 141 whose copied data 142 has not been generated in the information storage region 140 of other container 10 is present, the data management unit 213 determines that the copied data 142 of the present data 141 is to be generated.

Thereafter, when the data management unit 213 generates the copied data 142, the data management unit 213 determines whether any other server 1 is present that is other than the server 1, on which the container 10 storing the data 141 targeted for generation of the copied data 142 has been generated. Upon determining that the other server 1 is present as a result, the data management unit 213 decides to generate the copied data 142 in the information storage region 140 of the container 10 generated on the other server 1. It is to be noted that the data management unit 213 corresponds to the data management unit 50 explained with reference to FIG. 1.

The copy instruction transmitting unit 214 transmits the copy instruction of the data 141 to the container 10 decided by the data management unit 213.

### Outline of First Embodiment

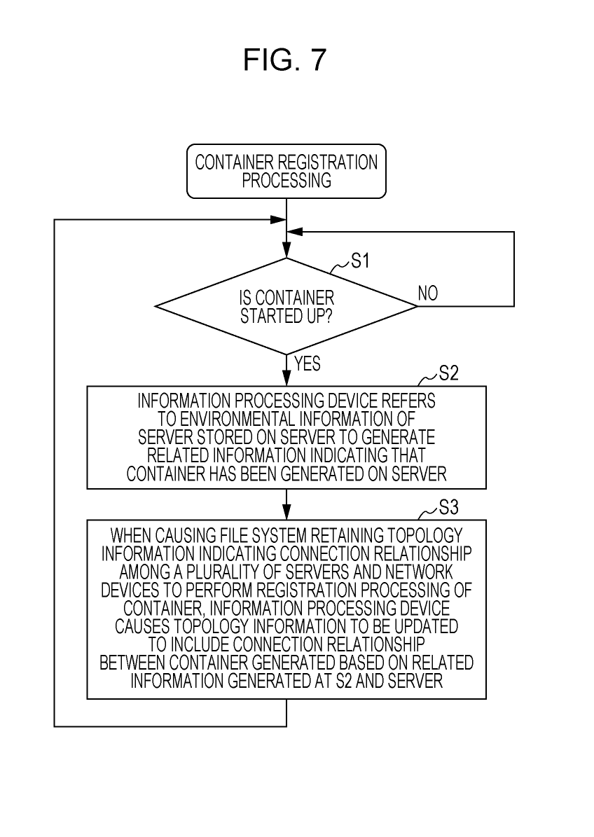

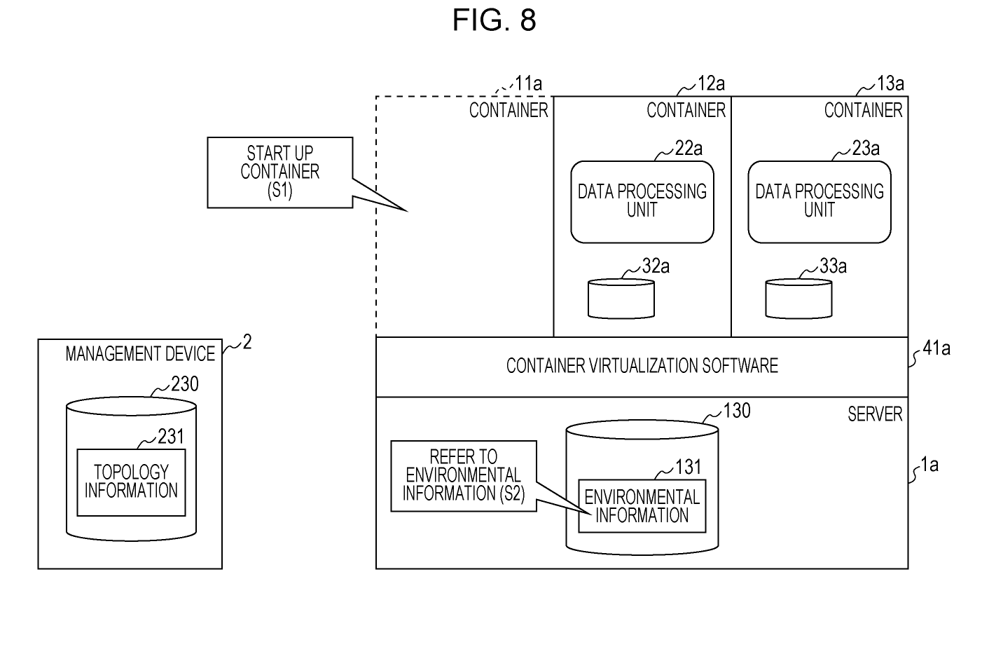

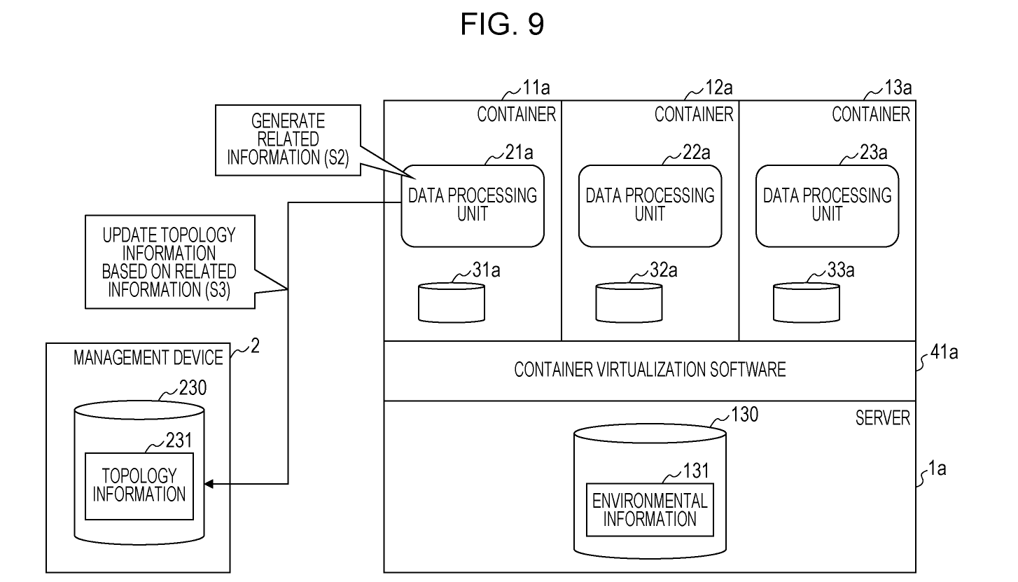

Next, an outline of a first embodiment will be explained. FIG. 7 is a flowchart explaining an outline of registration processing in the first embodiment. FIGS. 8 to 11 are diagrams explaining the outline of the registration processing in the first embodiment. With reference to FIGS. 8 to 11, the flowchart illustrated in FIG. 7 will be explained. It is to be noted that in FIGS. 8 and 9, illustration of the servers 1b and 1c is omitted.

The container 10 waits until startup of the subject container 10 is started, as illustrated in FIG. 7 (NO at S1). Specifically, the container 10 waits until the server 1 starts the startup of the subject container 10, for example.

Thereafter, when the startup of the subject container 10 is started (YES at S1), the container 10 refers to the environmental information 131 stored on the server 1 as illustrated in FIG. 8 (S2). Furthermore, the container 10 generates the related information 143 indicating that the container 10 has been generated on the server 1 as illustrated in FIG. 9 (S2).

Thereafter, when the container 10 causes the management device 2 (file system) retaining the topology information 231 indicating connection relationship among a plurality of servers and network devices to perform the registration processing of the subject container 10, the container 10 causes the topology information 231 to be updated (generated) to include connection relationship between the container 10 that has been generated based on the related information 143 generated in the processing at S2 and server 1, as illustrated in FIG. 9 (S3).

That is to say, each server 1 enables the environmental information 131 that identifies the subject server 1 to be referred by the container 10 generated on the subject server 1 in advance. Thereafter, when the container 10 performs startup of the subject container 10, each container 10 registers to the file system information including the information that identifies the subject container 10 and the information that identifies the server 1 on which the subject container 10 has been generated.

With this configuration, even when not having information of the server 1 on which the container 10 has been generated, the management device 2 (file system) is able to associate the information of the server 1 and the information of the container 10 generated on that server 1. This enables the file system to inhibit the copied data 142 of the data 141 in each container 10 from being generated in any container 10 on the same server 1.

When the file system explained with reference to FIG. 7 and others is HDFS by Hadoop®, the HDFS performs generation of the copied data of the data in each container 10 by using a function of Rack Awareness, for example. The function of the Rack Awareness is a function with which when generating the copied data, as a server for generating the copied data, a server that is contained in a rack connected to a switch other than the switch connected to the rack containing the server storing the targeted data for the copied data is selected. The function of Rack Awareness will be explained below.

[Function of Rack Awareness]

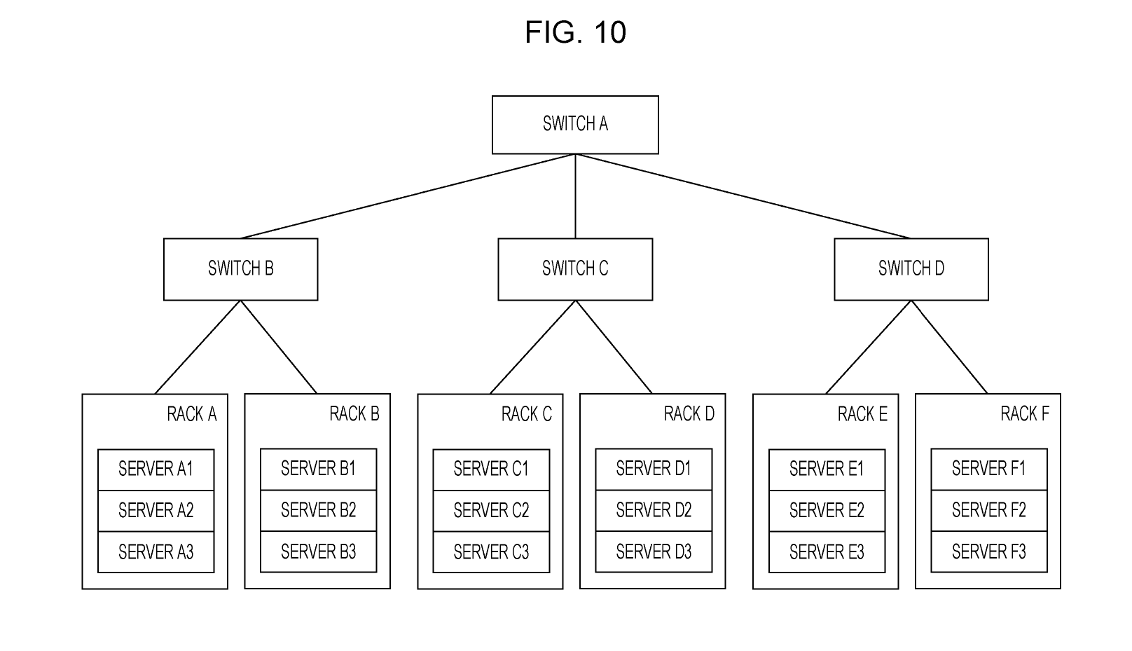

FIG. 10 is a diagram explaining a general function of Rack Awareness. In the example illustrated in FIG. 10, a switch A is connected to each of switches B, C, and D. The switch B is connected to a rack A containing servers A1, A2, and A3 and a rack B containing servers B1, B2, and B3. Furthermore, the switch C is connected to a rack C containing servers C1, C2, and C3 and a rack D containing servers D1, D2, and D3. Furthermore, the switch D is connected to a rack E containing servers E1, E2, and E3 and a rack F containing servers F1, F2, and F3.

In this case, when a master node (not illustrated) in the HDFS performs registration of information indicating a slave node (server), the master node registers information indicating each server and information indicating a switch connected to the server (switch connected by the rack containing the server) in an associated manner. Specifically, when the master node performs registration of information indicating the server A1, the master node registers information associating the information indicating the server A1 and information indicating the switch B connected by the rack A containing the server A1 (for example, switch B/server A1), for example.

Thereafter, for example, when generating the copied data of the data stored on the server A1, the master node refers to the information indicating the registered slave node to identify a container other than the container registered in association with the switch B (for example, the server E3 connected to the switch D). The master node then stores the copied data of the data stored in the container 11a in the identified container.

With this configuration, the master node is able to inhibit generation of inaccessible data even when any of the switches B, C, and D has a failure.

By contrast, in the information processing system 100 in the present embodiment, the function of Rack Awareness is used in a relationship among the switches, the servers, and the containers. A use method of the function of Rack Awareness in the present embodiment will be explained below.

[Use Method of Function of Rack Awareness in Present Embodiment]

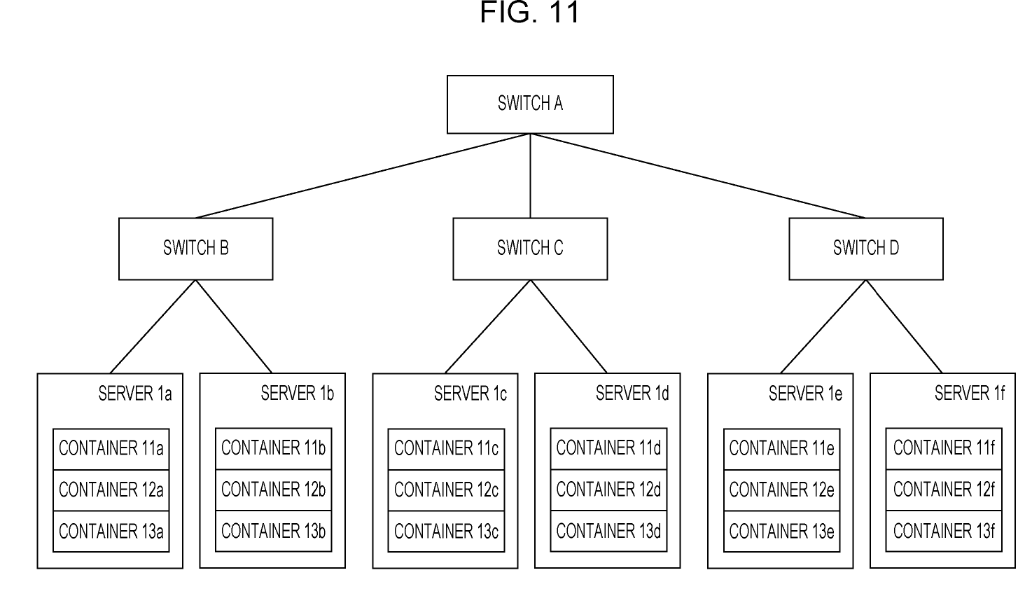

FIG. 11 is a diagram explaining a use method of function of Rack Awareness in the present embodiment. In the example illustrated in FIG. 11, the switch A is connected to each of switches B, C, and D, as in the case explained with reference to FIG. 10. The switch B is connected to a rack containing the server 1a on which the containers 11a, 12a, and 13a are generated and a rack containing the server 1b on which containers 11b, 12b, and 13b are generated. Furthermore, the switch C is connected to a rack containing the server is on which containers 11c, 12c, and 13c are generated and a rack containing a server 1d on which containers 11d, 12d, and 13d are generated. Furthermore, the switch D is connected to a rack containing a server 1e on which containers 11e, 12e, and 13e are generated and a rack containing the server 1f on which the containers 11f, 12f, and 13f are generated.

In this case, when the master node performs registration of information indicating the slave node (container), the master node registers the information indicating each container, information indicating the server on which the container is generated, and information indicating the switch connected by the server (switch connected by the rack containing the server) in an associated manner. Specifically, when the master node performs registration of information indicating the container 11a, the master node registers information associating the information indicating the container 11a, information indicating the server 1a on which the container 11a is generated, and information indicating the switch B connected by the rack containing the server 1a (for example, switch B/server 1a/container 11a), for example.

That is to say, the master node in the present embodiment uses the function of Rack Awareness after registering information combining the information indicating the server on which the container is generated and the information indicating the switch connected by the server (for example, switch B/server 1a) as information indicating the switch in the example explained in FIG. 10.

Thereafter, for example, when generating the copied data of the data stored in the container 11a, the master node refers to the information indicating the registered slave node to identify a container other than the container registered in association with the switch B and the server 1a (for example, the container 13e generated on the server 1e). The master node then generates the copied data of the data stored in the container 11a in the identified container.

With this configuration, the information processing system 100 uses only an existing function of the HDFS (Hadoop®) and thereby is able to inhibit the copied data of the data in each container 10 from being generated in any container 10 generated on the same server 1, without a new function mounted to the HDFS (Hadoop®).

### Details of First Embodiment

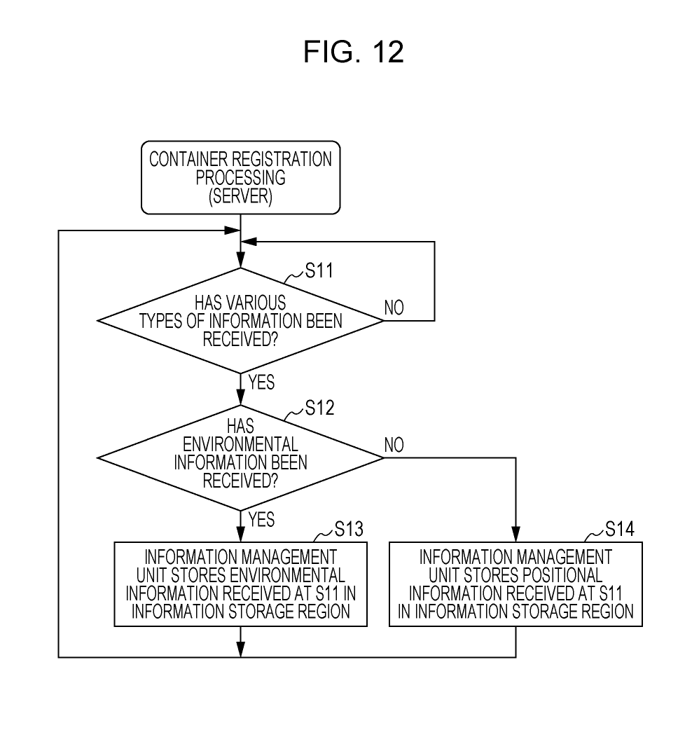

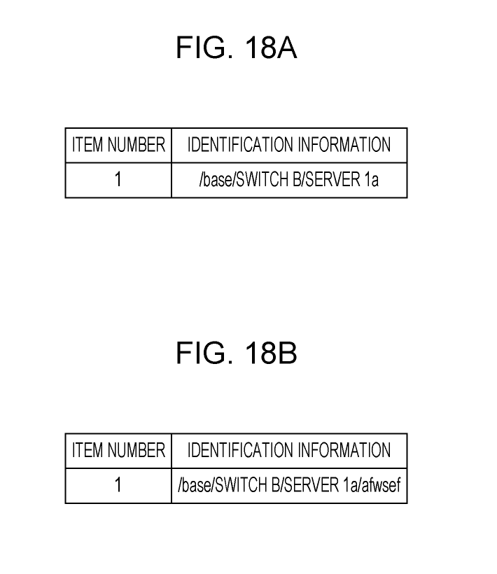

Next, details of the first embodiment will be explained. FIGS. 12 to 17 are flowcharts explaining the details of the registration processing in the first embodiment. Furthermore, FIGS. 18A to 22 are diagrams explaining the details of the registration processing in the first embodiment. With reference to FIGS. 18A to 22, the details of the registration processing illustrated in FIGS. 12 to 17 will be explained.

[Registration Processing Performed on Server]

Firstly, the registration processing performed on the server 1 itself will be explained. The information receiving unit 111 of the server 1 waits until receiving various types of information as illustrated in FIG. 12 (NO at S11). Specifically, the information receiving unit 111 waits until the business operator transmits the environmental information 131 or the positional information 132 via the operation terminal, for example.

When the information receiving unit 111 has received the environmental information 131 (YES at S11, YES at S12), the information management unit 112 of the server 1 stores the environmental information 131 received in the processing at S11 in the information storage region 130 (S13). Furthermore, when the information receiving unit 111 has received the positional information 132 (YES at S11, NO at S12), the information management unit 112 stores the positional information 132 received in the processing at S11 in the information storage region 130 (S14). Thereafter, the information receiving unit 111 waits until receiving the next information (NO at S11).

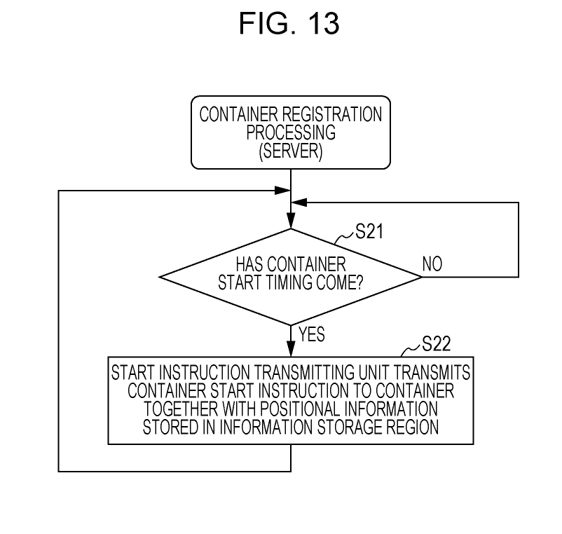

Furthermore, the timing determination unit 113 of the server 1 waits for the timing to start up the container as illustrated in FIG. 13 (NO at S21). The timing to start up the container may be the timing at which the information receiving unit 111 has received information that the container 10 is started up from the operation terminal (business operator), for example. Furthermore, the timing to start up the container may be the timing at which the current time has reached the time indicated by the container start information (not illustrated) stored in advance in the information storage region 130, for example.

When the timing to start up the container has come (YES at S21), the start instruction transmitting unit 114 of the server 1 transmits a start instruction of the container 10 to the container 10 to be started up together with the positional information 132 stored in the information storage region 130 (S22). Thereafter, the timing determination unit 113 waits until the next timing to start up the container (NO at S21).

With this configuration, the container 10 to be started up is able to acquire the environmental information 131 stored on the server 1, as described later.

[Registration Processing Performed in Container (1)]

Next, processing performed when the container 10 is started up out of the registration processing performed in the container 10 will be explained.

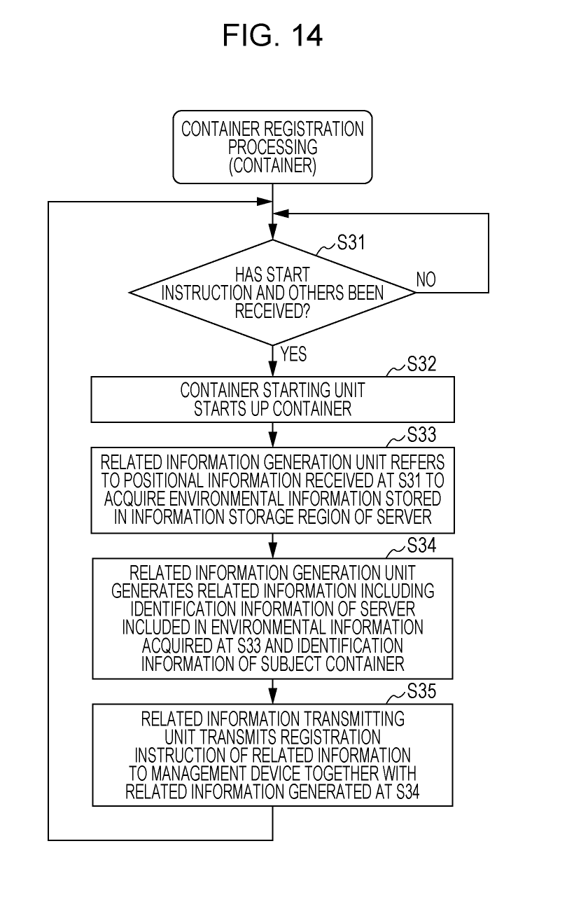

The start instruction receiving unit 121 of the container 10 that is stopped waits until receiving the start instruction and the positional information 132 from the server 1 as illustrated in FIG. 14 (NO at S31). When the start instruction receiving unit 121 has received the start instruction and others (YES at S31), the container starting unit 123 of the container 10 performs startup of the subject container 10 (S32). Furthermore, the information management unit 122 of the container 10 in this case stores the positional information 132 received by the start instruction receiving unit 121 in the information storage region 130.

Thereafter, the related information generation unit 124 of the container 10 refers to the positional information 132 received in the processing at S31 to acquire (refer to) the environmental information 131 stored in the information storage region 130 of the server 1 (S33). The related information generation unit 124 then generates the related information 143 including the identification information of the server 1 included in the environmental information 131 that has been acquired in the processing at S33 and the identification information of the subject container 10 (S34). A specific example of the environmental information 131 and the related information 143 will be explained below.

[Specific Example of Environmental Information and Related Information]

FIGS. 18A and 18B are diagrams explaining specific examples of the environmental information 131 and the related information 143. FIG. 18A is a diagram explaining a specific example of the environmental information 131 and FIG. 18B is a diagram explaining a specific example of the related information 143.

The environmental information 131 illustrated in FIG. 18A includes an “item number” that identifies each piece of information included in the environmental information 131 and “identification information” that identifies the server 1 storing the environmental information 131 as items. Specifically, in the environmental information 131 illustrated in FIG. 18A, to the “identification information” for information in which the “item number” is “1”, “/base/switch B/server 1a” is set.

The related information 143 illustrated in FIG. 18B includes an “item number” that identifies each piece of information included in the related information 143 and “identification information” that identifies the container 10 started up in the processing at S32 as items. To the “identification information”, information combining the identification information in the environmental information 131 acquired in the processing at S33 and the identification information of the container 10 started up in the processing at S32 is set. Specifically, in the related information 143 illustrated in FIG. 18B, to the “identification information” for information in which the “item number” is “1”, “/base/switch B/server 1a/afwsef” is set.

That is to say, in the processing at S34, the related information generation unit 124 generates not only the identification information of the subject container 10 but also the related information 143 including the identification information of the server 1a included in the environmental information 131 acquired in the processing at S33 and the identification information of the switch connected to the server 1a (switch connected to the rack containing the server 1a).

With this configuration, the management device 2 (file system) is able to inhibit the copied data 142 of the data 141 in each container 10 from being generated in any container 10 generated on the same server 1, as described later.

Back to FIG. 14, the related information transmitting unit 125 of the container 10 transmits a registration instruction of the related information 143 to the management device 2 together with the related information 143 generated in the processing at S34 (S35). Thereafter, the start instruction receiving unit 121 waits until next time receiving the start instruction and others (NO at S31).

[Registration Processing Performed in Management Device (1)]

Next, out of the registration processing performed in the management device 2, processing performed when the startup of the container 10 is performed will be explained.

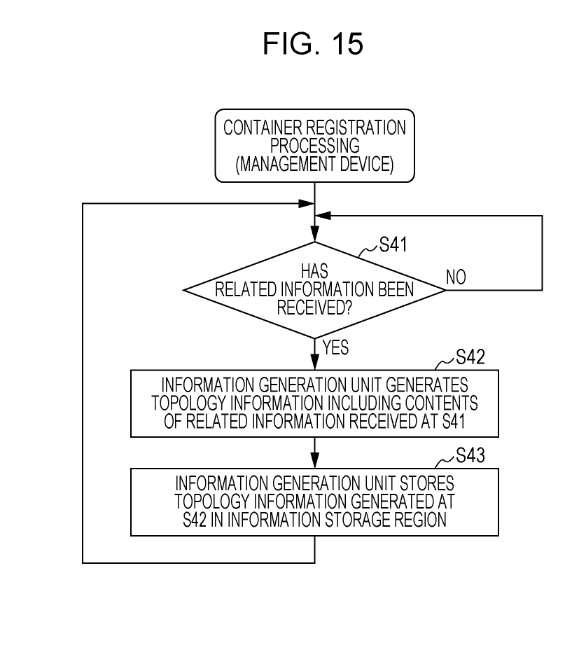

The related information receiving unit 211 of the management device 2 waits until receiving the related information 143 transmitted from the container 10 that has been started up, as illustrated in FIG. 15 (NO at S41). Thereafter, when the related information 143 has been received (YES at S41), the information generation unit 212 of the management device 2 generates the topology information 231 including the contents of the related information 143 received in the processing at S41 (S42). Furthermore, the information generation unit 212 stores the generated topology information 231 in the information storage region 230 (S43).

Thereafter, the related information receiving unit 211 waits until receiving the next related information 143 (NO at S41). A specific example of the topology information 231 will be explained below.

[Specific Example of Topology Information]

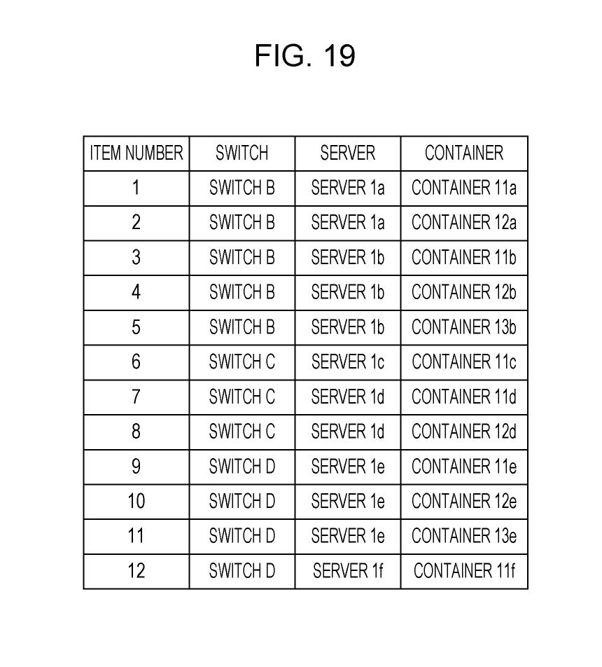

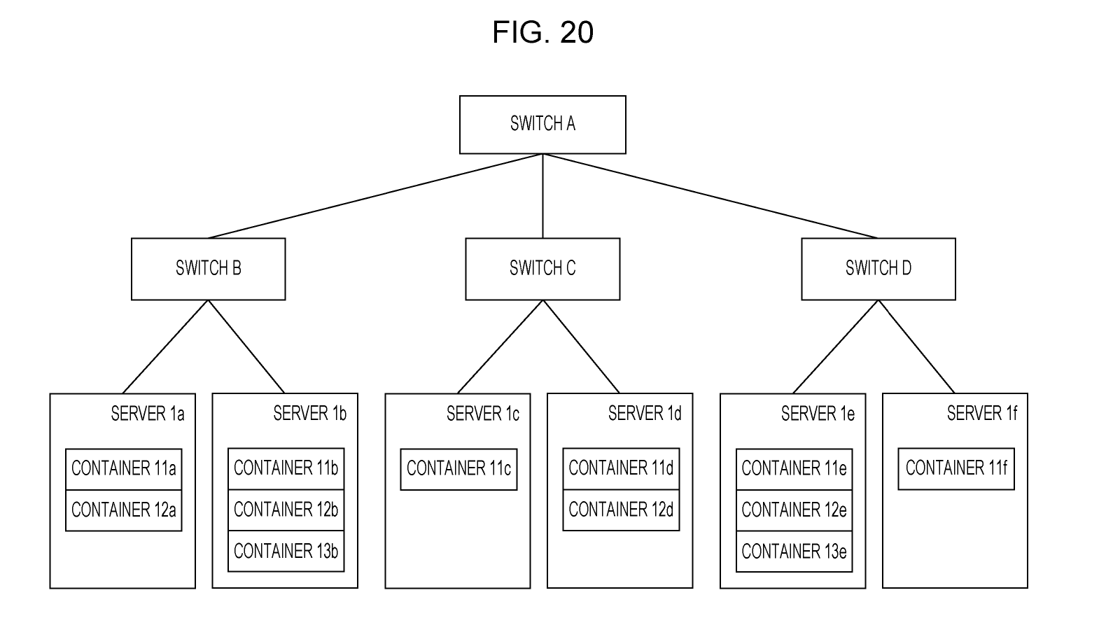

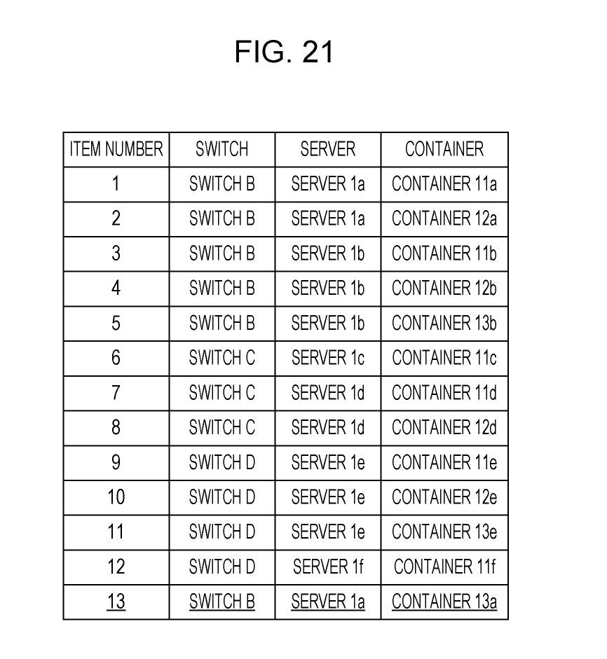

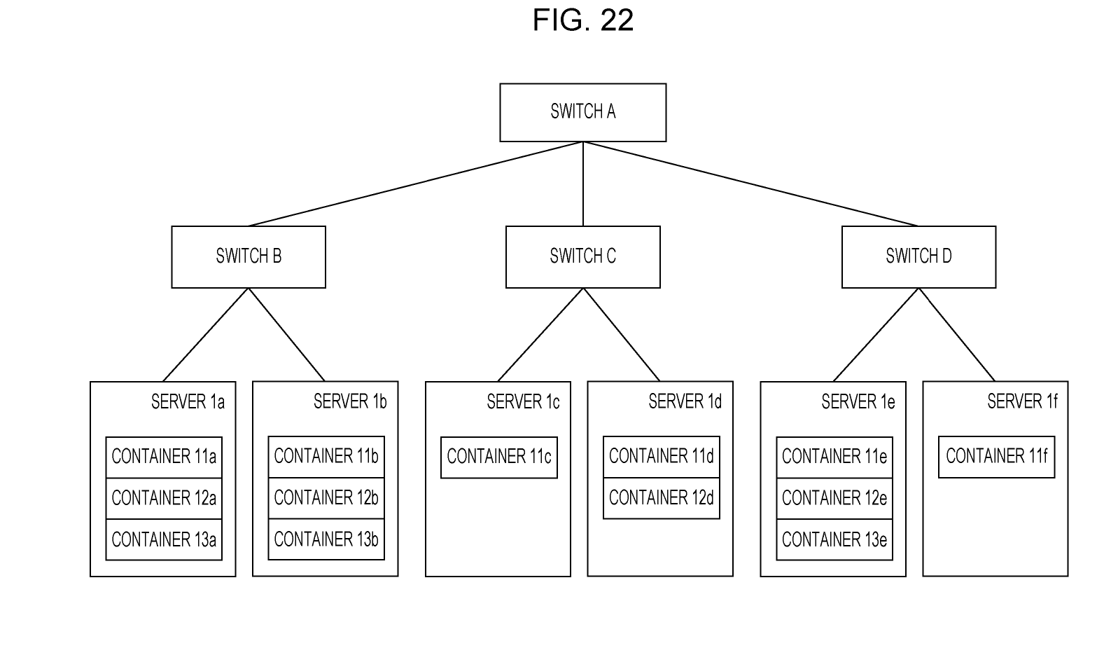

FIGS. 19 and 21 are diagrams explaining specific examples of the topology information 231. The topology information 231 illustrated in FIG. 19 corresponds to the configuration illustrated in FIG. 20. Furthermore, the topology information 231 illustrated in FIG. 21 corresponds to the configuration illustrated in FIG. 22.

The topology information 231 illustrated in FIG. 19 includes an “item number” that identifies each piece of information included in the topology information 231 and a “switch” that identifies each switch, a “server” that identifies each server 1, and a “container” that identifies each container 10 as items. To the “switch”, the identification information of the switch directly connected to the rack containing each server 1 is set.

Specifically, in the example illustrated in FIG. 20, the container 11a is generated on the server 1a. The switch connected to the server 1a (rack containing the server 1a) is the switch B. Accordingly, in the information in which the “item number” is “1” in the topology information 231 illustrated in FIG. 19, the “switch B” is set to the “switch”, the “server 1a” is set to the “server”, and the “container 11a” is set to the “container”.

Furthermore, in the example illustrated in FIG. 20, the container 12d is generated on the server 1d. The switch connected to the server 1d (rack containing the server 1d) is the switch C. Accordingly, in the information in which the “item number” is “8” in the topology information 231 illustrated in FIG. 19, the “switch C” is set to the “switch”, the “server 1d” is set to the “server”, and the “container 12d” is set to the “container”. Explanation of other types of information included in FIGS. 19 and 20 is omitted.

Furthermore, for example, as illustrated in FIG. 22, when the container 13a is started up on the server 1a, the information generation unit 212 updates the topology information 231 illustrated in FIG. 19 in the processing at S42.

Specifically, the related information receiving unit 211 in this case receives the related information 143 associating information indicating the container 13a, information indicating the server 1a, and information indicating the switch B from the container 13a. Accordingly, the information generation unit 212 in this case adds information in which the “switch B” is set to the “switch”, the “server ha” is set to the “server”, and the “container 13a” is set to the “container” (information in which the “item number” is “13”), as indicated by underlines in FIG. 21.

With this configuration, the management device 2 is able to refer to the topology information 231 on which the latest condition of the container 10 generated on the server 1 is reflected, as described later.

[Registration Processing Performed in Management Device (2)]

Next, out of the registration processing performed in the management device 2, processing performed when the copied data 142 of the data 141 stored in the container 10 is generated will be explained.

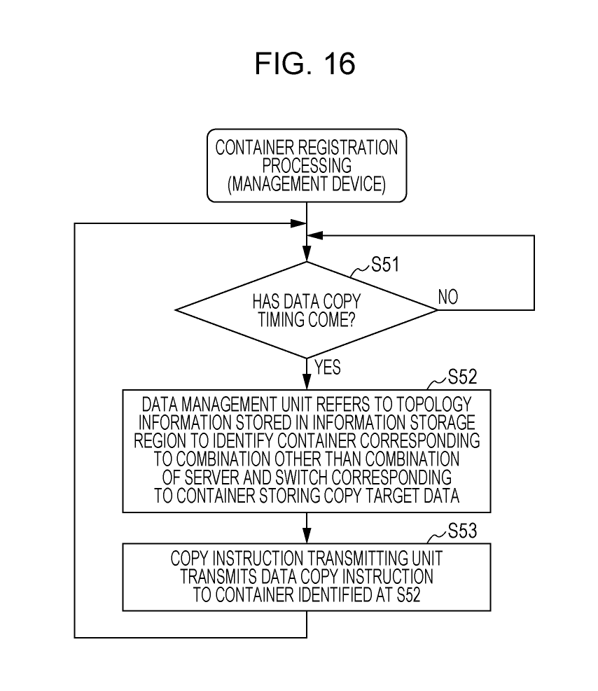

The data management unit 213 of the management device 2 waits for the timing to copy the data, as illustrated in FIG. 16 (NO at S51). The timing to copy the data may be the timing at which the startup of the container 10 has been performed in the processing at S32, for example. Furthermore, the timing to copy the data may be the timing at which the business operator has performed an input for generating the copied data 142 of the data 141 stored in the container 10 via the operation terminal, for example.

When the timing to copy the data has come (YES at S51), the data management unit 213 refers to the topology information 231 stored in the information storage region 230 to identify the container 10 corresponding to a combination other than the combination of the server 1 and the switch corresponding to the container 10 storing the copy target data 141 (S52).

Specifically, in the example illustrated in FIG. 22, when generating the copied data 142 of the data 141 stored in the container 11a, the data management unit 213 refers to the topology information 231 illustrated in FIG. 21 to identify the “switch B” and the “server 1a” which are pieces of information set to the “switch” and the “server” for the information in which the “container 11a” is set to the “container” (information in which the “item number” is “1”). The data management unit 213 then identifies the container indicated by information set to the “container” in the information in which a combination other than the combination of the switch B and the server 1a is set to the “switch” and the “server” (for example, information in which the “item number” is “3”) as the container storing the copied data 142.

Thereafter, the copy instruction transmitting unit 214 of the management device 2 transmits a copy instruction of the data 141 to the container 10 identified in the processing at S52 (S53). Thereafter, the data management unit 213 waits for the next timing to copy the data (NO at S51).

[Registration Processing Performed in Container (2)]

Next, out of the registration processing performed in the container 10, processing performed when the copied data 142 of the data 141 stored in the container 10 is generated will be explained.

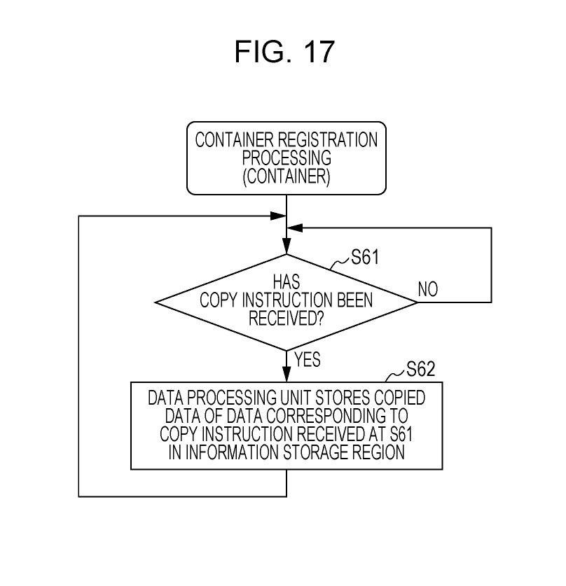

The copy instruction receiving unit 126 of the container 10 waits until receiving the copy instruction of the data 141 transmitted by the management device 2 as illustrated in FIG. 17 (NO at S61). When the copy instruction receiving unit 126 has received the copy instruction of the data 141 (YES at S61), the data processing unit 127 of the container 10 stores the copied data 142 of the data 141 corresponding to the copy instruction received in the processing at S61 in the information storage region 140 (S62).

Referring again to FIG. 5, specifically, the data processing unit 127 accesses the container 10 stored in the data 141 corresponding to the copy instruction received in the processing at S61 to acquire the data 141 corresponding to the copy instruction. The data processing unit 127 then stores the acquired data 141 in the information storage region 140 as the copied data 142.

With this configuration, the management device 2 (file system) is able to inhibit the copied data 142 of the data 141 in each container 10 from being generated in any container 10 generated on the same server 1 when causing the copied data 142 to be stored in each container 10.

As described above, in the present embodiment, when the startup of the subject container 10 is performed, the container 10 refers to the environmental information 131 stored on the server 1 and causes the file system to generate the topology information 231 including the information indicating that the container 10 has been generated on the server 1, thereby performing registration of the subject container 10 in the file system.

That is to say, each server 1 enables the environmental information 131 that identifies the subject server 1 to be referred by each container 10 generated on the subject server 1 in advance. Thereafter, when the container 10 performs startup of the subject container 10, each container 10 registers to the file system information including the information that identifies the subject container 10 and the information that identifies the server 1 on which the subject container 10 has been generated.

With this configuration, even when not having information of the server 1 on which the container 10 has been generated, the management device 2 (file system) is able to associate the information of the server 1 and the information of the container 10 generated on that server 1. This enables the file system to inhibit the copied data 142 of the data 141 in each container 10 from being generated in any container 10 on the same server 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
when a container generated on a server is started up, generating related information indicating that the container has been generated on the server while referring to environmental information of the server that is stored on the server; and
when causing a file system that retains topology information indicating connection relationship among a plurality of servers and network devices to perform registration processing of the container, causing the topology information to be updated to include connection relationship between the container that has been generated based on the related information and the server.

2. The non-transitory, computer-readable recording medium according to claim 1, wherein, when the file system has received information indicating that the container has been generated on the server from the container, the file system performs generation of the topology information while referring to the received information.

3. The non-transitory, computer-readable recording medium according to claim 1, wherein the server:
transmits information indicating a storage position of the environmental information on the server to the container before the container refers to the environmental information, and
refers to the environmental information in accordance with the information indicating the storage position in the generating the related information.

4. The non-transitory, computer-readable recording medium according to claim 1, wherein, in the causing the topology information to be updated, the file system is caused to retain the topology information with identification information of the container and identification information of the server registered in a manner associated with each other.

5. The non-transitory, computer-readable recording medium according to claim 4, wherein the file system:
determines whether any other container is present that has been generated on another server while referring to the topology information, and
upon determining that the other container is present, stores a copy of data stored in the container in the other container.

6. The non-transitory, computer-readable recording medium according to claim 1, wherein, in the causing the topology information to be updated, the file system is caused to retain the topology information with identification information of the container, identification information of the server, and identification information of the network device registered in a manner associated with each other.

7. The non-transitory, computer-readable recording medium according to claim 6, wherein the network device is a switch arranged in position nearest from the server.

8. The non-transitory, computer-readable recording medium according to claim 6, wherein the file system:
determines whether any other container is present that has been generated on another server corresponding to another network device corresponding to the server while referring to the topology information, and upon determining that the other container is present, stores a copy of data stored in the container in the other container.

9. An apparatus comprising:
a memory; and
a processor coupled to the memory and configured to:
when a container generated on a server is started up, generate related information indicating that the container has been generated on the server while referring to environmental information of the server that is stored on the server, and
when causing a file system that retains topology information indicating connection relationship among a plurality of servers and network devices to perform registration processing of the container, cause the topology information to be updated to include connection relationship between the container that has been generated based on the related information and the server.

10. A method comprising:
when a container generated on a server is started up, generating related information indicating that the container has been generated on the server while referring to environmental information of the server that is stored on the server; and
when causing a file system that retains topology information indicating connection relationship among a plurality of servers and network devices to perform registration processing of the container, causing the topology information to be updated to include connection relationship between the container that has been generated based on the related information and the server.

11. A method of container registration comprising:
determining whether a startup of a first container has started;
referring to environmental information stored on a first server on which the first container has been generated;
generating related information indicating that the first container has been generated on the first server;
generating topology information regarding the first server and the first container;
registering the first container with a file system; and
updating the topology information to enable the file system to associate the server and the first container generated on the first server.

12. The method of claim 11, wherein the startup includes transmitting positional information to the first container.

13. The method of claim 11, wherein the related information includes identification information of the first server and identification information of the first container.

14. The method of claim 11, wherein the topology information includes information associating identification information of the first server with identification information of the first container.

15. The method of claim 11, further comprising determining whether data stored in an information storage region of the first container is to be copied.

16. The method of claim 11 further comprising determining whether copied data is to be generated.

17. The method of claim 16 further comprising determining whether a second server is present.

18. The method of claim 17 further comprising storing the copied data in a second container generated on the second server.
